(19) United States
(12) Patent Application Publication
(10) Pub. No.: US 2019/0130869 A1
(43) Pub. Date: May 2, 2019

(54) HEAD-MOUNTED DISPLAY DEVICES AND METHODS FOR COLOR DIFFERENCE ENHANCEMENT

(71) Applicant: Quanta Computer Inc., Taoyuan City (TW)

(72) Inventors: Jung-Wen CHANG, Taoyuan City (TW); Chien-Hung LIN, Taoyuan City (TW)

(21) Appl. No.: 15/863,647

(22) Filed: Jan. 5, 2018

(30) Foreign Application Priority Data
Oct. 27, 2017 (TW) 106137085

(51) Int. Cl. G09G 5/02; G09G 5/10; G09G 5/00; G02B 27/01

(52) U.S. Cl. CPC G09G 5/02; G09G 5/10; G09G 5/003; G02B 27/0172; G02B 2027/0178; G09G 2354/00; G02B 2027/0116; G02B 2027/0138; G02B 2027/014; G09G 2320/0666

(57) ABSTRACT

A head-mounted display device including a camera, a controller, and a display system is provided. The camera captures an original image of the surrounding environment. The controller determines an area of a predetermined color in the original image, and increases at least one of the saturation level and the intensity level of the original image in the area to generate a color-difference enhanced image. The display system displays the color-difference enhanced image.

### CROSS REFERENCE TO RELATED APPLICATIONS

This Application claims priority of Taiwan Application No. 106137085, filed on Oct. 27, 2017, the entirety of which is incorporated by reference herein.

### BACKGROUND OF THE APPLICATION

### Field of the Application

The application relates generally to technologies of head-mounted display devices, and more particularly, to head-mounted display devices and methods for improving the lives of achromates.

### Description of the Related Art

Photoreceptor cells are light-sensitive cells in the retina, which absorb light and convert it into electrical signals that pass to the brain through the optic nerve. There are two types of photoreceptor cells: cone cells and rod cells. The cone cells are mainly responsible for fine visual detail, color, central and day vision (also called photopic vision). There are three types of cone cells, each of which detects colored light of a different wavelength (red, green and blue). Deficient color vision, or so-called color blindness, may occur when one or more of the color cone cells are absent, nonfunctioning, or detecting a different color than normal.

The rod cells contain biological pigments called rhodopsin which allow the rod cells to be more light-sensitive than the cone cells. However, the rod cells can only differentiate light from dark, but cannot identify colors. The rod cells are mainly responsible for black-and-white, peripheral, and night vision (also called scotopic vision). Night blindness is generally caused by impaired functioning of the rod cells.

Statistically speaking, there are approximately 300 million people around the world that suffer from the condition of deficient color vision, or color blindness. Due to these achromates being unable to correctly identify colors, dangerous situations may occur in their daily lives. For example, traffic accidents happen when they cannot identify between a red light and a green light, and health hazards occur when taking the wrong drugs because they cannot identify the colors of different pills. In addition, difficulties may crop up at work when achromates are assigned tasks involving color information.

Therefore, it is desirable to have a solution for improving the lives of achromates.

### BRIEF SUMMARY OF THE APPLICATION

In order to solve the aforementioned problems, the present application proposes head-mounted display devices and methods for enhancing the color difference of one or more specific colors in the images of the surrounding environment, thereby enabling achromates to identify colors correctly.

In one aspect of the application, a head-mounted display device comprising a first camera, a controller, and a display system is provided. The first camera is configured to capture a first original image of a surrounding environment. The controller is configured to determine a first area of a predetermined color in the first original image, and increase at least one of a saturation level and an intensity level of the first original image in the first area to generate a first color-difference enhanced image. The display system is configured to display the first color-difference enhanced image.

In another aspect of the application, a method for color difference enhancement, executed by a head-mounted display device comprising a first camera and a display system, is provided. The method comprises the steps of: capturing, via the first camera, a first original image of a surrounding environment; determining a first area of a predetermined color in the first original image; increasing at least one of a saturation level and an intensity level of the first original image in the first area to generate a first color-difference enhanced image; and displaying, via the display system, the first color-difference enhanced image.

Other aspects and features of the application will become apparent to those with ordinary skill in the art upon review of the following descriptions of specific embodiments of the head-mounted display devices and methods for color difference enhancement.

### BRIEF DESCRIPTION OF THE DRAWINGS

The application can be more fully understood by reading the subsequent detailed description and examples with references made to the accompanying drawings, wherein:

FIG. 1 is a block diagram illustrating the system architecture of a head-mounted display device according to an embodiment of the application;

FIG. 2 is a schematic diagram illustrating an exemplary component arrangement of the head-mounted display device 100;

FIGS. 3A to 3C depict three illustrative embodiments of the top view of a user/wearer and the head-mounted display device 100; and

FIG. 4 is a flow chart illustrating the method for color difference enhancement according to an embodiment of the application.

### DETAILED DESCRIPTION OF THE APPLICATION

The following description is made for the purpose of illustrating the general principles of the application and should not be taken in a limiting sense. It should be understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

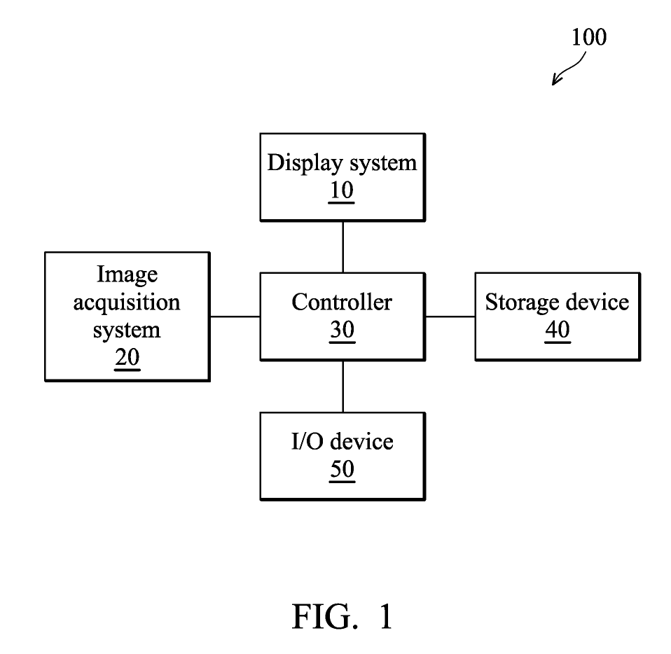

FIG. 1 is a block diagram illustrating the system architecture of a head-mounted display device according to an embodiment of the application. The head-mounted display device 100 includes a display system 10, an image acquisition system 20, a controller 30, a storage device 40, and an Input-Output (I/O) device 50.

The display system 10 is responsible for displaying visual content or text, such as the images captured by the image acquisition system 20, and/or the color-difference enhanced image generated by the controller 30.

In one embodiment, the display system 10 may include one or more Liquid-Crystal Displays (LCDs), Light-Emitting Diode (LED) displays, Organic LED (OLED) displays, Electronic Paper Displays (EPDs), or Cathode Ray Tube (CRT) displays, etc.

In another embodiment, the display system 10 may include an optical engine and see-through optics, wherein the optical engine may project visual content or text to be displayed on the see-through optics. The optical engine may include one or more projectors, such as a nano-projector, pico-projector, micro-projector, femto-projector, Laser-based projector, holographic projector, or the like. The see-through optics may be referred to as an optical assembly which may include a mirror/reflector and at least one lens, such as one waveguide lens and one translucent correction lens adhered to the waveguide lens, which enables proper viewing of the surrounding environment through the see-through optics regardless of whether the optical engine is on or off.

The image acquisition system 20 is responsible for capturing images of the surrounding environment. The image acquisition system 20 may include one or more cameras, such as image camera(s), depth camera(s), or environment-understanding camera(s), etc., wherein an image camera may be a general camera capable of image acquisition, a depth camera may be a greyscale, RGB (Red/Green/Blue), or CMYK (Cyan/Magenta/Yellow/Key) camera capable of depth sensing, and an environment understanding cameras may be a greyscale, RGB, or CMYK cameras capable of sensing objects in the surrounding environment.

The controller 30 may be a general-purpose processor, Micro-Control Unit (MCU), Digital Signal Processor (DSP), application processor, Graphics Processing Unit (GPU), or Holographic Processing Unit (HPU), or any combination thereof, which includes various circuits for providing the function of data and image processing/computing, sending a series of frame data (e.g. representing images of visual content or text) to the display system 10, receiving image data from the image acquisition system 20, storing and retrieving data to and from the storage device 40, and receiving parameter adjustment instructions from the user/wearer of the head-mounted display device 100 via the I/O device 50.

In particular, the controller 30 is responsible for processing the images captured by the image acquisition system 20 to enhance the color differences of the images. Also, the controller 30 coordinates the display system 10, the image acquisition system 20, the storage device 40, and the I/O device 50 for performing the method of the present application.

As will be appreciated by persons skilled in the art, the circuits in the controller 30 will typically comprise transistors that are configured in such a way as to control the operation of the circuitry in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 40 is a non-transitory computer-readable storage medium, including a memory, such as a FLASH memory or a Non-volatile Random Access Memory (NVRAM), or a magnetic storage device, such as a hard disk or a magnetic tape, or an optical disc, or any combination thereof for storing frame/image data, and instructions or program code of communication protocols, applications, and/or the method for color difference enhancement of the present application.

The I/O device 50 may include one or more buttons, keyboards, touch sensors, microphones, speakers, and/or light devices, etc., which is responsible for providing a Man-Machine Interface (MMI) for receiving parameter adjustment instructions from the user/wearer of the head-mounted display device 100, and/or outputting prompt/feedback signals.

In one embodiment, the I/O device 50 may include multiple buttons. One button may be configured for the user/wearer to select the color adjustment mode which determines specific color(s) to be adjusted. For example, the first color adjustment mode may be configured for protanopia, in which light-red is the target color to be adjusted. The second color adjustment mode may be configured for deuteranopia, in which light-green is the target color to be adjusted. The third color adjustment mode may be configured for tritanopia, in which light-blue or light-yellow is the target color to be adjusted. Alternatively, the first and second color adjustment modes may be integrated as a single color adjustment mode for both protanopia and deuteranopia, in which both light-red and light-green are the target colors to be adjusted. In addition, one button may be configured for the user/wearer to determine the target saturation level of the color(s) to be adjusted, one button may be configured for the user/wearer to determine the hue offset of the color(s) to be adjusted, and one button may be configured for the user/wearer to determine the target intensity level of the color(s) to be adjusted.

Please note that the light-red described herein refers to all tones of light-red, such as pink, citrus red, coral red, etc. Likewise, the light-green described herein refers to all tones of light-green, such as spring green, apple green, jade green, etc., the light-blue described herein refers to all tones of light-blue, such as sky blue, sea blue, baby blue, etc., and the light-yellow described herein refers to all tones of light-yellow, such as cream yellow, buff yellow, ocher, etc.

It should be understood that the components described in the embodiment of FIG. 1 are for illustrative purposes only and are not intended to limit the scope of the application. For example, the head-mounted display device 100 may include other components, such as a power supply, a wireless communication device, and/or a Global Positioning System (GPS) device, wherein the power supply may be a mobile/replaceable battery providing power to all the other components of the head-mounted display device 100, the wireless communication device may include a Bluetooth or Wireless-Fidelity (WiFi) chipset enabling wireless communications with other mobile communication devices, such as smartphones or panel PCs, and the GPS device may provide location information of the head-mounted display device 100 for use of some location-based services or applications.

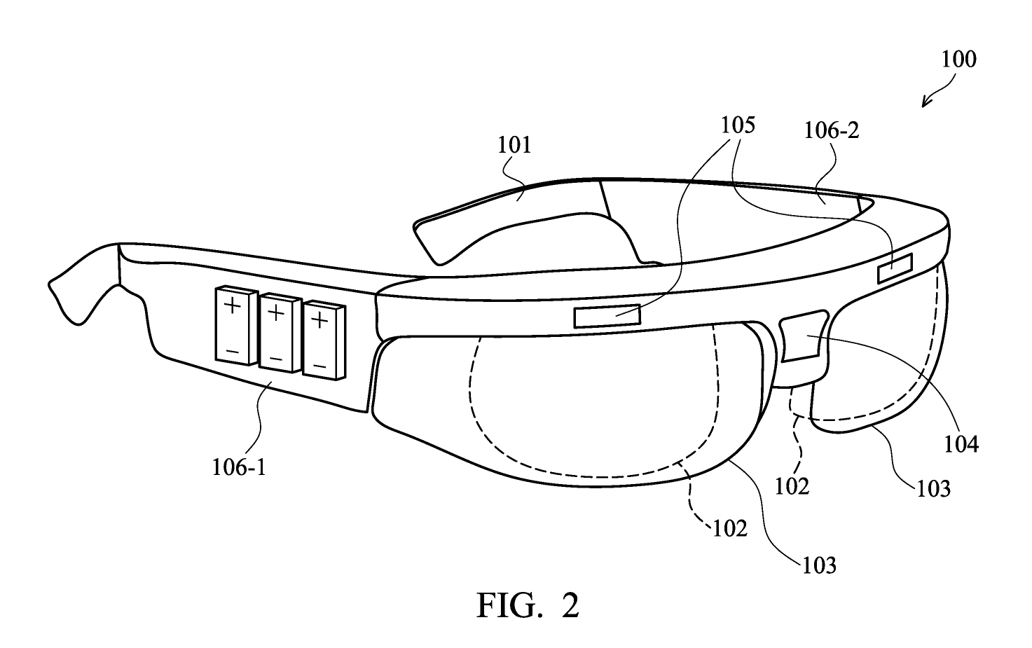

FIG. 2 is a schematic diagram illustrating an exemplary component arrangement of the head-mounted display device 100. In this embodiment, the head-mounted display device 100 is implemented as a headset or eyepiece.

As shown in FIG. 2, the display system 10 may be disposed in the lower-front portion 102 of the main frame 101 of the headset/eyepiece. A lens portion 103 is disposed in front of the display system 10 for protecting the display system 10 from being exposed directly to the surrounding environment. The image acquisition system 20 may be disposed in the upper-front portion 104 or 105 of the main frame 101 of the headset/eyepiece. The I/O device 50, including 3 buttons for selecting a color adjustment mode, a saturation level, and a hue offset, respectively, may be disposed in the arm portion 106-1 of the main frame 101. The rest of the components, such as the controller 30 and the storage device 40, may be embedded in the arm portion 106-2 or any unused portion of the main frame 101.

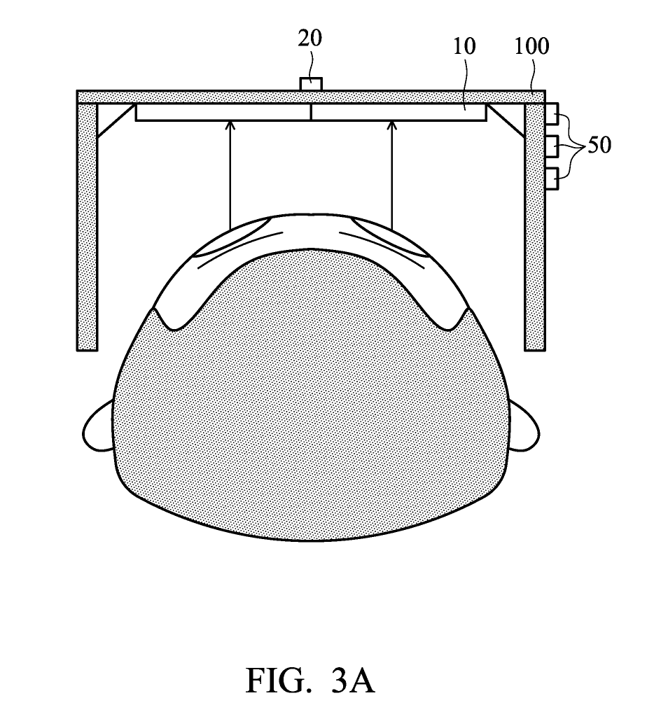

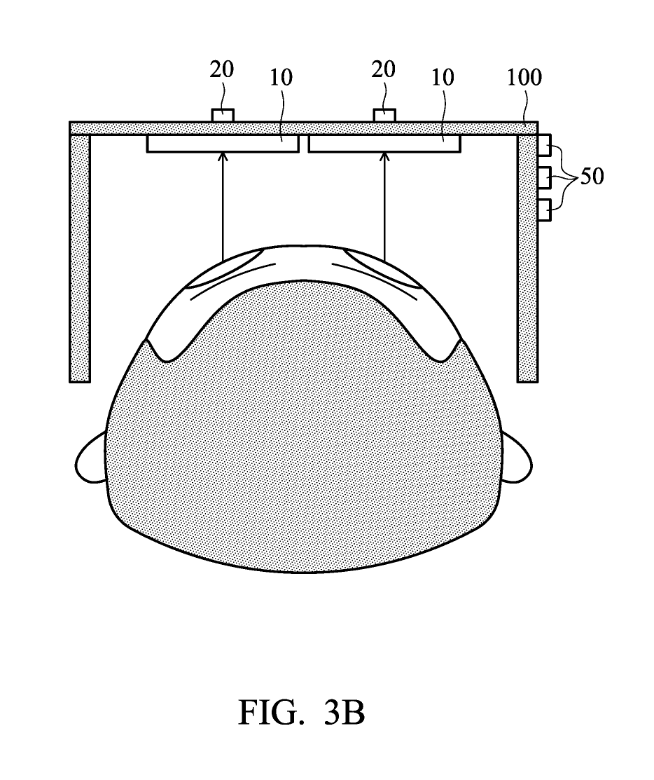

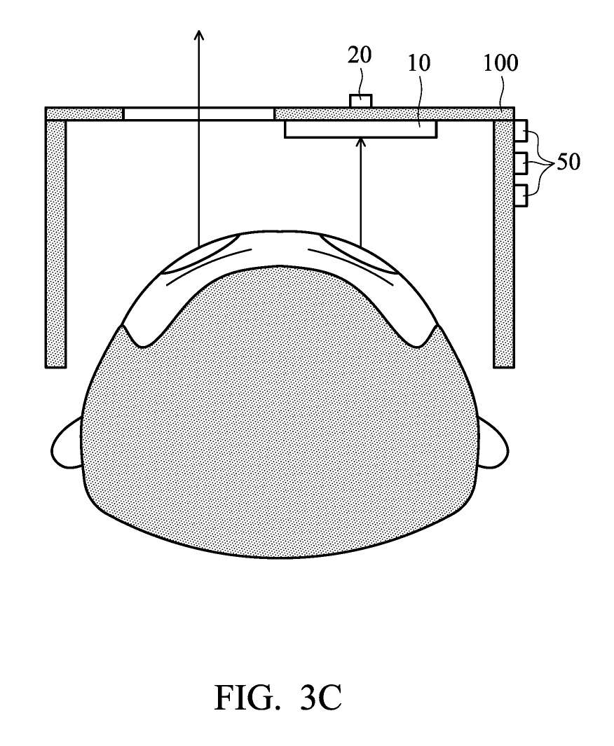

FIG. 3A depicts an illustrative embodiment of the top view of a user/wearer and the head-mounted display device 100. In this embodiment, the image acquisition system 20 includes a single camera and is disposed in the center-front portion 107 of the head-mounted display device 100. The size of the display system 10 roughly covers both the left eye sight and the right eye sight of the user/wearer. That is, the user/wearer can clearly see the visual content displayed by the display system 10, or the eye sights of the user/wearer are completely occupied by the visual content displayed by the display system 10. The I/O devices 50 are disposed at the right arm of the head-mounted display device 100.

FIG. 3B depicts another illustrative embodiment of the top view of a user/wearer and the head-mounted display device 100. In this embodiment, the image acquisition system 20 includes two cameras which are disposed in the left-front portion and right-front portion of the head-mounted display device 100 and are used to capture the images of the left eye sight and the right eye sight of the user/wearer. The display system 10 includes two display devices, wherein the size of each display device roughly covers a respective one of the left eye sight and the right eye sight of the user/wearer, and the display devices are used to display the color-difference enhanced images generated by the controller 30 processing the images captured by the cameras. The I/O devices 50 are disposed at the right arm of the head-mounted display device 100.

FIG. 3B depicts yet another illustrative embodiment of the top view of a user/wearer and the head-mounted display device 100. In this embodiment, the image acquisition system 20 includes a single camera which is disposed in the right-front portion of the head-mounted display device 100 and is used to capture the image of the right eye sight of the user/wearer. The left-front portion of the head-mounted display device 100 is disposed with a viewfinder which may be provided with a hollow space or see-through optics and may enable the left eye sight of the user/wearer to see through the head-mounted display device 100. The display system 10 includes a single display device, wherein the size of the display device roughly covers the right eye sight of the user/wearer, and the display device is used to display the color-difference enhanced image generated by the controller 30 processing the image captured by the camera. The I/O devices 50 are disposed at the right arm of the head-mounted display device 100.

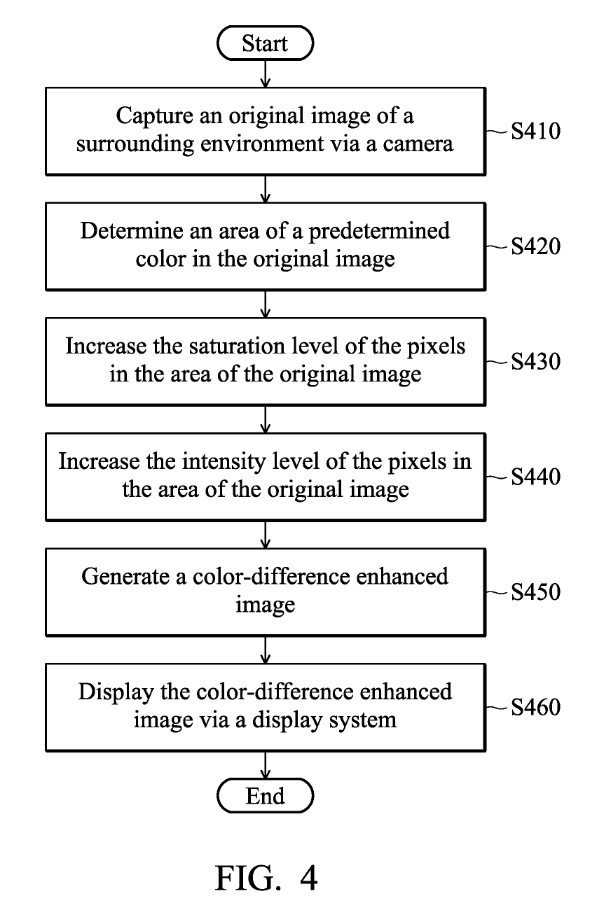

FIG. 4 is a flow chart illustrating the method for color difference enhancement according to an embodiment of the application. In this embodiment, the method for color difference enhancement is applied to a head-mounted display device including at least a camera and a display system, such as the head-mounted display device 100.

To further clarify, the method for color difference enhancement may be implemented as a software module produced with program code, and the software module may be loaded and executed by a controller of the head-mounted display device.

To begin, the head-mounted display device captures an original image of a surrounding environment via the camera (step S410). In one embodiment, the head-mounted display device may include a single camera to capture a single image. In another embodiment, the head-mounted display device may include two cameras, each of which is used to capture the image of a respective one of the left eye sight and the right eye sight of the user/wearer.

Next, the head-mounted display device performs a color difference enhancement on the original image. The detailed description of the color difference enhancement is given in the following steps S420˜S440.

In step S420, the head-mounted display device determines an area of a predetermined color in the original image (step S420). For example, if the user/wearer of the head-mounted display device has the condition of red-green color blindness, the predetermined color may be light-red and/or light-green; if the user/wearer of the head-mounted display device has the condition of blue-yellow color blindness, the predetermined color may be light-blue and/or light-yellow.

In step S430, the head-mounted display device increases the saturation level of the pixels in the area of the original image (step S430). In step S440, the head-mounted display device increases the intensity level of the pixels in the area of the original image (step S440). Alternatively, in another embodiment, step S440 may be omitted.

In one embodiment, the saturation level may be increased by adding the same offset to the hues of the pixels in the area of the original image, wherein the pixels correspond to any tone of the predetermined color. For example, if the predetermined color is light-red, then after increasing the saturation level, citrus red may become ruby red, pink may become bright red, and ruby red may become scarlet red.

In another embodiment, the saturation level may be increased by changing all tones of the predetermined color into the most saturated tone of the color category. For example, if the predetermined color is light-red, then after increasing the saturation level, all tones of light-red, including pink, citrus red, and coral red, etc., may become bright red. For implementation, the pixels with RGB values in a certain range may be selected and their RGB values may be replaced with a set of predetermined values. For example, the range of RGB values of the citrus red category may be set to [R=255, G=97˜128, B=0˜33], and for all pixels with RGB values in this range, their RGB values may be replaced with the RGB value [R=255, G=0, B=0] of bright red (also may be understood as an operation of hue offset). Likewise, a range of RGB value may be configured to define the pink category or the coral red category, and the same operation may be carried out for all pixels with RGB values in the range, so as to replace the RGB values of the pixels with the RGB value [R=255, G=0, B=0] of bright red.

In one embodiment, the head-mounted display device may receive a parameter adjustment instruction from the user/wearer, which indicates at least one of the following: the predetermined color, the target saturation level of the predetermined color, and the target intensity level of the predetermined color. According to the parameter adjustment instruction, the head-mounted display device may determine which color to enhance (i.e., the predetermined color in step S420), and increase the saturation level or hue offset (i.e., the parameter used in step S430) and the intensity level (i.e., the parameter used in step S440) of the pixels in the area of the original image.

Subsequent to step S440, the head-mounted display device generates a color-difference enhanced image (step S450). After that, the head-mounted display device displays the color-difference enhanced image via the display system (step S460), and the method ends.

In view of the foregoing embodiments, it will be appreciated that the present application proposes a head-mounted display device which realizes color difference enhancement for specific colors in the images of the surrounding environment, thereby enabling achromates to identify colors correctly. Advantageously, the plight of achromates being congenitally unable to identify certain colors will be improved.

While the application has been described by way of example and in terms of preferred embodiment, it should be understood that the application cannot be limited thereto. Those who are skilled in this technology can still make various alterations and modifications without departing from the scope and spirit of this application. Therefore, the scope of the present application shall be defined and protected by the following claims and their equivalents.

Note that use of ordinal terms such as “first”, “second”, etc., in the claims to modify a claim element does not by itself connote any priority, precedence, or order of one claim element over another or the temporal order in which acts of the method are performed, but are used merely as labels to distinguish one claim element having a certain name from another element having the same name (except for use of ordinal terms), to distinguish the claim elements.

1. A head-mounted display device, comprising:
a first camera, configured to capture a first original image of a surrounding environment;
an Input-Output device, configured to receive a parameter adjustment instruction from a user of the head-mounted display device, which allows the user to indicate at least one of the following: a predetermined color, a target saturation level of the predetermined color, and a target intensity level of the predetermined color;
a controller, configured to determine a first area of the predetermined color in the first original image, and increase at least one of a saturation level and an intensity level of the first original image in the first area according to at least one of the target saturation level and the target intensity level of the predetermined color, to generate a first color-difference enhanced image; and
a display system, configured to display the first color-difference enhanced image.

2. (canceled)

3. The head-mounted display device of claim 1, wherein the first original image corresponds to one of a left eye sight and a right eye sight of a wearer of the head-mounted display device, and the first color-difference enhanced image is displayed in the one of the left eye sight and the right eye sight of the wearer.

4. The head-mounted display device of claim 3, further comprising:
a second camera, configured to capture a second original image of the surrounding environment, wherein the second original image corresponds to the other one of the left eye sight and the right eye sight of the wearer;
wherein the controller is further configured to determine a second area of the predetermined color in the second original image, and increase at least one of a saturation level and an intensity level of the second original image in the second area to generate a second color-difference enhanced image;
wherein the display system is further configured to display the second color-difference enhanced image in the other one of the left eye sight and the right eye sight of the wearer.

5. The head-mounted display device of claim 4,
wherein the controller is further configured to increase at least one of the saturation level and the intensity level of the second original image in the second area according to at least one of the target saturation level and the target intensity level of the predetermined color.

6. A method for color difference enhancement, executed by a head-mounted display device comprising a first camera and a display system, the method comprising:
capturing, via the first camera, a first original image of a surrounding environment;
receiving, via an Input-Output device of the head-mounted display device, a parameter adjustment instruction from a user of the head-mounted display device, which allows the user to indicate at least one of the following: a predetermined color, a target saturation level of the predetermined color, and a target intensity level of the predetermined color;
determining a first area of the predetermined color in the first original image;
increasing at least one of a saturation level and an intensity level of the first original image in the first area according to at least one of the target saturation level and the target intensity level of the predetermined color, to generate a first color-difference enhanced image; and
displaying, via the display system, the first color-difference enhanced image.

7. (canceled)

8. The method of claim 6, wherein the first original image corresponds to one of a left eye sight and a right eye sight of a wearer of the head-mounted display device, and the first color-difference enhanced image is displayed in the one of the left eye sight and the right eye sight of the wearer.

9. The method of claim 8, further comprising:
capturing, via a second camera, a second original image of the surrounding environment, wherein the second original image corresponds to the other one of the left eye sight and the right eye sight of the wearer;
determining a second area of the predetermined color in the second original image;
increasing at least one of a saturation level and an intensity level of the second original image in the second area to generate a second color-difference enhanced image; and
displaying, via the display system, the second color-difference enhanced image in the other one of the left eye sight and the right eye sight of the wearer.

10. The method of claim 9, further comprising:
increasing at least one of the saturation level and the intensity level of the second original image in the second area according to at least one of the target saturation level and the target intensity level of the predetermined color.
